(19) United States
(12) Patent Application Publication
(10) Pub. No.: US 2011/0218068 A1
(43) Pub. Date: Sep. 8, 2011

(54) STATIONARY GUIDE FOR CHAIN TRANSMISSION

(75) Inventors: Koichi Shimosaka, Osaka (JP); Atsushi Kawano, Osaka (JP); Atsushi Kumakura, Osaka (JP)

(73) Assignee: TSUBAKIMOTO CHAIN CO., Osaka (JP)

(21) Appl. No.: 13/031,891

(22) Filed: Feb. 22, 2011

(30) Foreign Application Priority Data
Mar. 4, 2010 (JP) 2010-047957

(51) Int. Cl. F16H 7/18

(52) U.S. Cl. 474/140

(57) ABSTRACT

A stationary guide for an engine timing chain is mounted by engagement of two longitudinally space mounting holes with two pins protruding from an engine block. At least one of the holes is formed with a stop wall positioned to prevent improper reverse mounting of the guide, and preferably positioned so that its abutment with the end of a mounting pin positions the guide in proper alignment with the normal path of travel of the timing chain.

### CROSS REFERENCE TO RELATED APPLICATIONS

This application claims priority on the basis of Japanese Patent Application 2010-047957, filed on Mar. 4, 2010. The disclosure of Japanese Patent Application 2010-047957 is herein incorporated by reference.

### FIELD OF THE INVENTION

The invention relates to a stationary guide for use in a chain transmission such as the timing drive of an automobile engine, i.e., a transmission in which an endless transmission chain such as roller chain or a silent chain is engaged with and driven by a crankshaft sprocket and in driving relationship with one or more camshaft sprockets.

### BACKGROUND OF THE INVENTION

Stationary guides for guiding traveling timing chains by sliding contact therewith prevent vibration and swinging movement of the chain. A typical stationary guide, having two longitudinally spaced mounting holes for receiving mounting pins protruding from the wall of an engine block, is described in United States patent publication 2005/0096167, published on May 5, 2005.

Prior art stationary guides are typically mounted on two pins projecting from the engine block, and those pins have the same diameter. The pins P fit into two mounting holes portions 921 and 922, as shown in FIGS. 25 and 26. Because the pins have the same diameter, and each of them can fit into either mounting hole in the guide, it is possible for the guide to be mounted backward, i.e., with its chain entry and chain exit ends reversed, as shown by the broken lines in FIGS. 25 and 26. The pins P, which protrude from a wall of an engine block B should fit into the mounting holes 921 and 922 of the stationary guide 900 with the guide correctly positioned as shown by solid lines in FIGS. 25 and 26.

If the guide is mounted in a reversed position, the timing chain can travel incorrectly, generating abnormal noises and causing unexpected wear and damage to the guide.

Additionally, in the conventional stationary guide, the extent to which the pins P protrude into the mounting holes 921 and 922 of the guide can vary, causing widthwise shifting of the path of travel of the timing chain, causing excessive contact between the chain and a sidewall of the guide, and generating abnormal noise and excessive wear of the guide.

### SUMMARY OF THE INVENTION

Aspects of this invention solve the aforementioned problems by avoiding erroneous mounting of a stationary guide with its chain entry end and chain exit ends reversed, by ensuring a normal locus of travel of the chain, and by avoiding noise and wear generated by excessive contact between a timing chain and a side wall of the guide.

The stationary guide according to the invention comprises a rail and a rail support. The rail has a longitudinal chain-engaging surface extending along the longitudinal direction of the rail. The rail support has first and second longitudinally spaced mounting holes for respectively receiving first and second supporting pins protruding from an engine block. At least the first mounting hole has an internal stop wall offset sufficiently to engage the second supporting pin and thereby prevent the rail support from being erroneously mounted on the supporting pins when an attempt is made to mount the rail support with the first supporting pin in the second mounting hole and the second supporting pin in the first mounting hole.

If an attempt is made to engage the guide with the mounting pins on an engine block wall while the chain entry and chain exit ends of the guide are reversed, a pin abuts the stop wall and is prevented from being inserted into the mounting hole. Accordingly, it is possible to avoid erroneous installation of the guide on the engine block.

The internal stop wall can be advantageously positioned within the first mounting hole at a location at which it is abutted by the first supporting pin when the rail on the rail support is aligned with, and in normal sliding engagement with, the chain. Because the mounting pin abuts the internal stop wall, the guide can be aligned with the chain without special adjustment steps.

Accordingly, the mounting of the stationary guide can be carried out accurately and simply. Additionally, because the guide can be readily aligned with the normal locus of travel of the timing chain, it is possible to avoid noises that would otherwise be generated as a result of widthwise misalignment of the guide.

### BRIEF DESCRIPTION OF DRAWINGS

FIG. 1 is a schematic front elevational view of an engine timing transmission incorporating a stationary guide according to a first embodiment of the invention;

FIG. 2 is an exploded perspective view illustrating the mounting of the stationary guide of the first embodiment;

FIG. 3 is an exploded perspective view showing the mounting of the guide as in FIG. 2, but from the opposite direction;

FIG. 4 is a schematic elevational view showing the correct mounting of the stationary guide;

FIG. 5 is a schematic elevational view showing incorrect mounting of the stationary guide;

FIG. 6 is a front elevational view of the stationary guide of the first embodiment;

FIG. 7 is an enlarged fragmentary front elevational view showing the chain entry end of the stationary guide;

FIG. 8 is a cross-sectional view taken on section plane 8-8 in FIG. 7;

FIG. 9 is a schematic sectional view illustrating correct insertion of a mounting pin into a mounting hole of the guide according to the first embodiment;

FIG. 10 is a schematic sectional view illustrating an attempt to insert a mounting pin into a mounting hole of the guide according to the first embodiment when the guide is incorrectly positioned;

FIG. 11 is an enlarged fragmentary front elevational view showing the chain entry end of a stationary guide according to a second embodiment of the invention;

FIG. 12 is a schematic sectional view illustrating correct insertion of a mounting pin into a mounting hole of the guide according to the second embodiment;

FIG. 13 is an enlarged fragmentary front elevational view showing the chain entry end of a stationary guide according to a third embodiment of the invention;

FIG. 14 is a schematic sectional view illustrating correct insertion of a mounting pin into a mounting hole of the guide according to the third embodiment;

FIG. 15 is an enlarged fragmentary front elevational view showing the chain entry end of a stationary guide according to a fourth embodiment of the invention;

FIG. 16 is a schematic sectional view illustrating correct insertion of a mounting pin into a mounting hole of the guide according to the fourth embodiment;

FIG. 17 is an enlarged fragmentary front elevational view showing the chain entry end of a stationary guide according to a fifth embodiment of the invention;

FIG. 18 is a schematic sectional view illustrating correct insertion of a mounting pin into a mounting hole of the guide according to the fifth embodiment;

FIG. 19 is an enlarged fragmentary front elevational view showing the chain entry end of a stationary guide according to a sixth embodiment of the invention;

FIG. 20 is a schematic sectional view illustrating correct insertion of a mounting pin into a mounting hole of the guide according to the sixth embodiment;

FIG. 21 is an enlarged fragmentary front elevational view showing the chain entry end of a stationary guide according to a seventh embodiment of the invention;

FIG. 22 is a schematic sectional view illustrating correct insertion of a mounting pin into a mounting hole of the guide according to the seventh embodiment;

FIG. 23 is an exploded perspective view illustrating the mounting of a stationary guide according to an eighth embodiment;

FIG. 24 is an exploded perspective view showing the mounting of the guide as in FIG. 23, but from the opposite direction;

FIG. 25 is an exploded perspective view illustrating the mounting of a conventional stationary guide of a comparative example is to be fixed; and

FIG. 26 is an exploded perspective view showing the mounting of the conventional guide as in FIG. 25, but from the opposite direction.

### DETAILED DESCRIPTION OF THE PREFERRED EMBODIMENTS

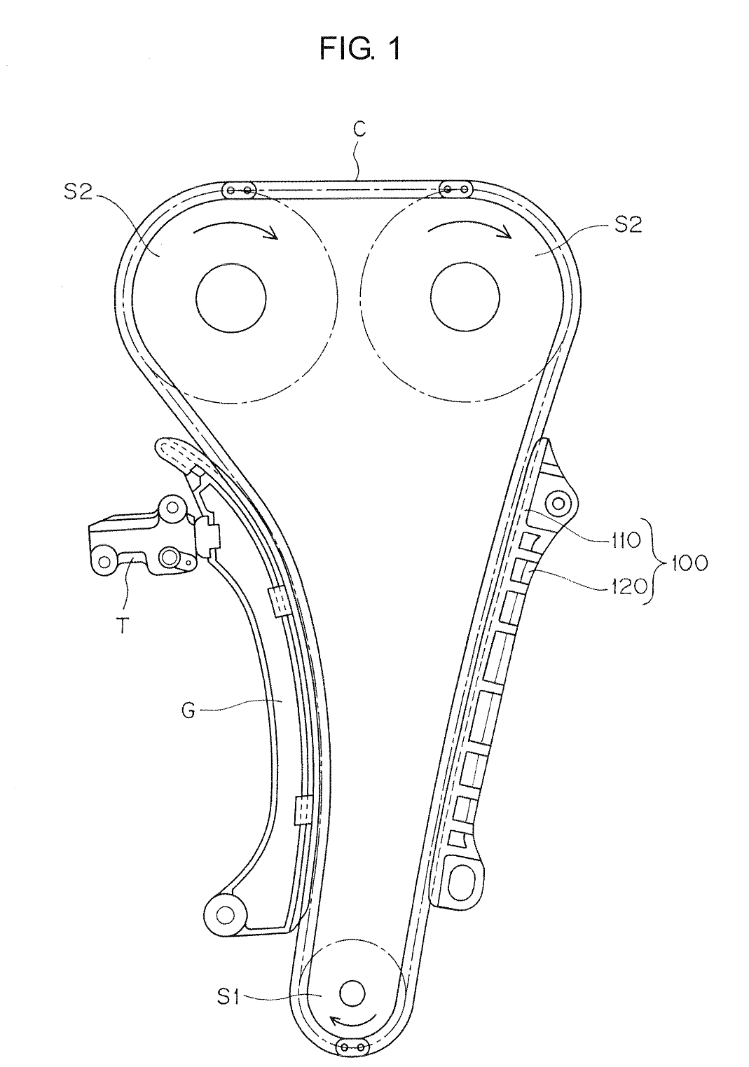

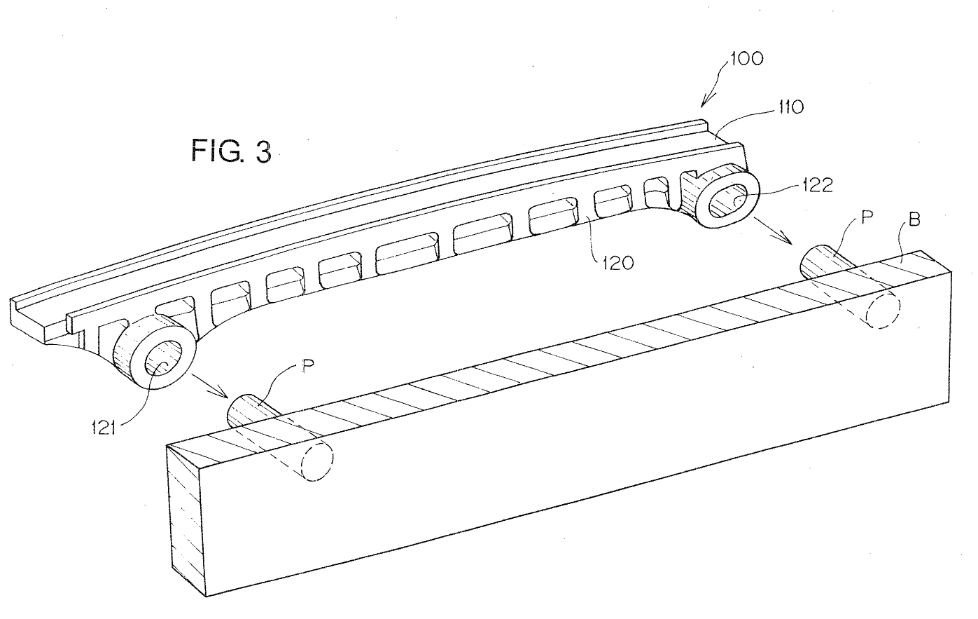

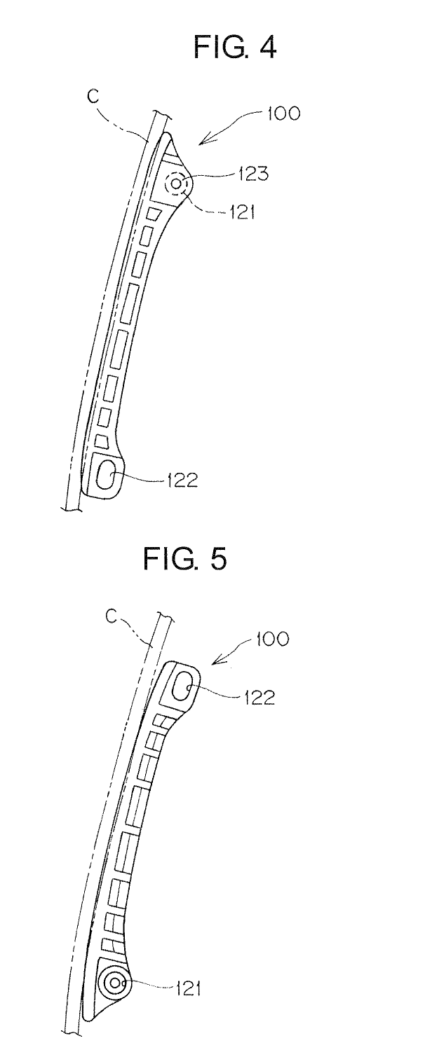

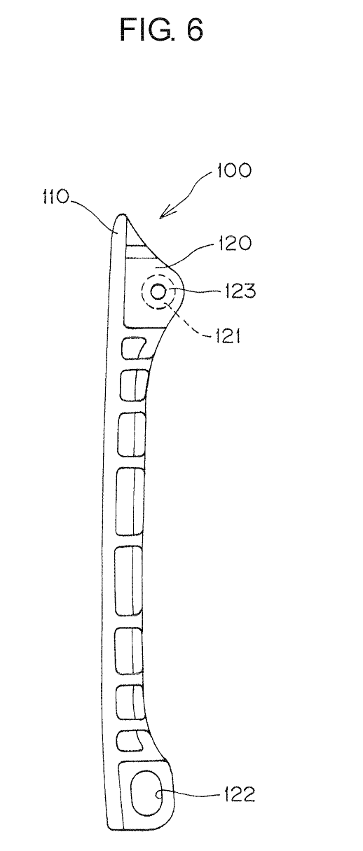

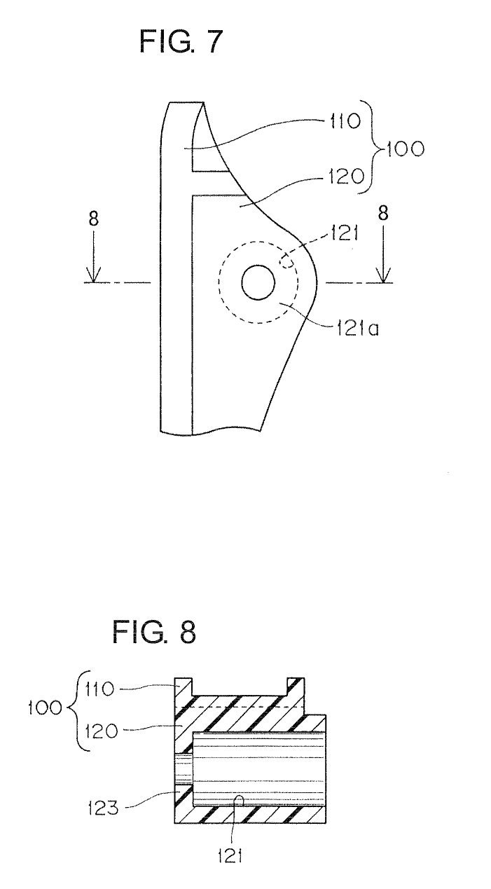

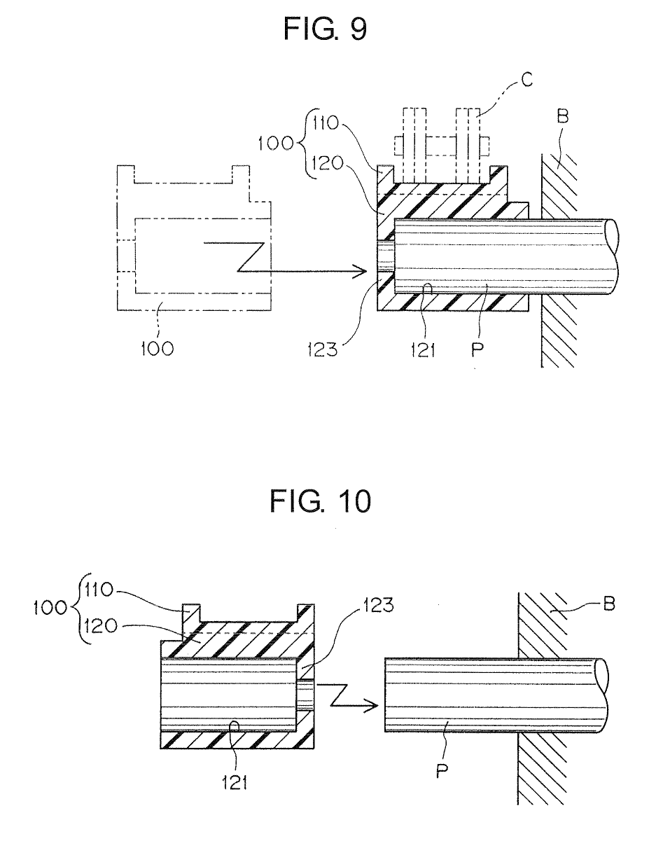

A first embodiment of a stationary guide 100 of the invention will first be explained with reference to FIGS. 1 through 10.

That is, as shown in FIG. 1, a stationary guide 100 for an automobile engine timing chain is attached to a wall (not shown in FIG. 1) of the engine block. The timing chain C is a roller chain that transmits power from a crankshaft sprocket S1 to two driven camshaft sprockets S2. The guide 100 is in sliding contact with the chain and guides the travel of the chain.

FIG. 1 also shows a movable guide G that applies tension to the timing chain C. Guide G is in sliding contact with the side of the chain that travels from the driving sprocket S1 toward the driven sprockets S2. A tensioner T biases the movable guide G toward the chain in order to apply the tension to the chain.

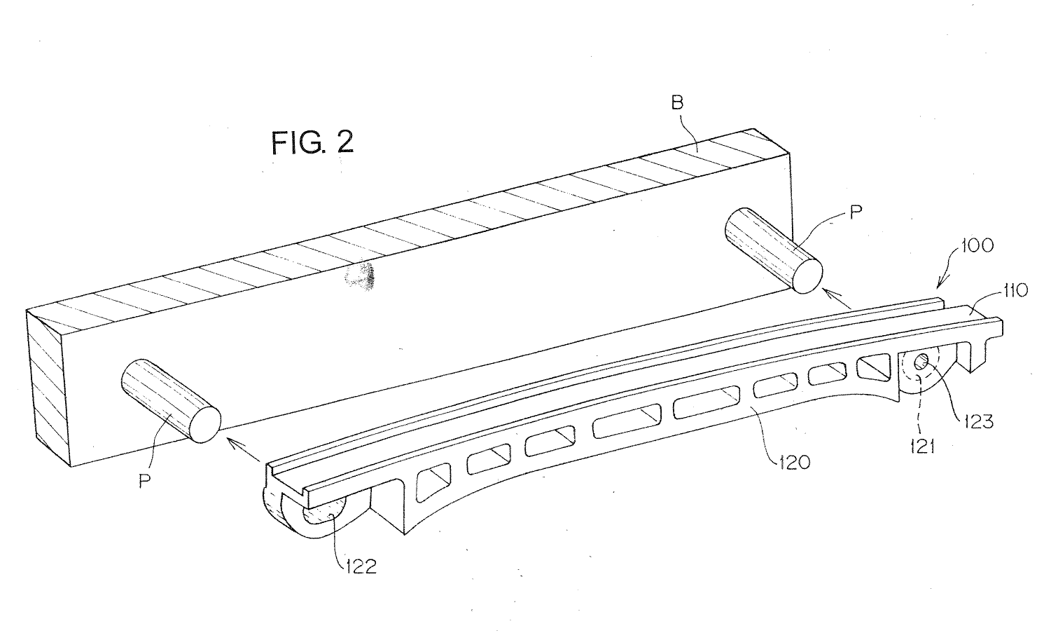

As shown in FIGS. 1 through 10, the stationary guide 100 includes a rail 110 for controlling the travel of the timing chain, and a rail support 120 for supporting the rail 110 so that the rail extends along the longitudinal direction of the portion of the chain with which it is in sliding contact. The rail support 120 is fixed to an engine block wall B (FIGS. 2-10) by fitting two holes, 121 and 122, in the rail support 120 respectively onto two supporting pins P projecting from the engine block wall B.

Whereas hole 121 is circular, hole 122 is an elongated hole having an oval cross-section, allowing for longitudinal expansion and contraction of the guide.

The hole 121 in the rail support 120 is provided with a cap-like stop wall 123 for preventing the guide from being erroneously attached to the engine block wall in the reverse direction as shown in FIG. 5. If an attempt is made to insert pins P into holes 121 and 122 with the holes reversed, i.e., with the chain entry end where the chain exit end should be, and vice versa, a pin P abuts the cap-like stop wall 123 and is prevented from entering hole 121 as shown in FIG. 10.

The axial position of the stop wall 123 in hole 121 is such that it abuts the pin P when guide is at the desired position, i.e., when the guide is properly aligned with the traveling path of the chain. Accordingly, it is unnecessary to take special measures to adjust the insertion depth of the mounting pin P in hole 121. The stop wall, therefore, not only makes it possible to avoid mounting the guide in reverse, i.e., with it chain exit end where the chain entry end should be, but also simplifies accurate alignment of the guide with the travel path of the chain.

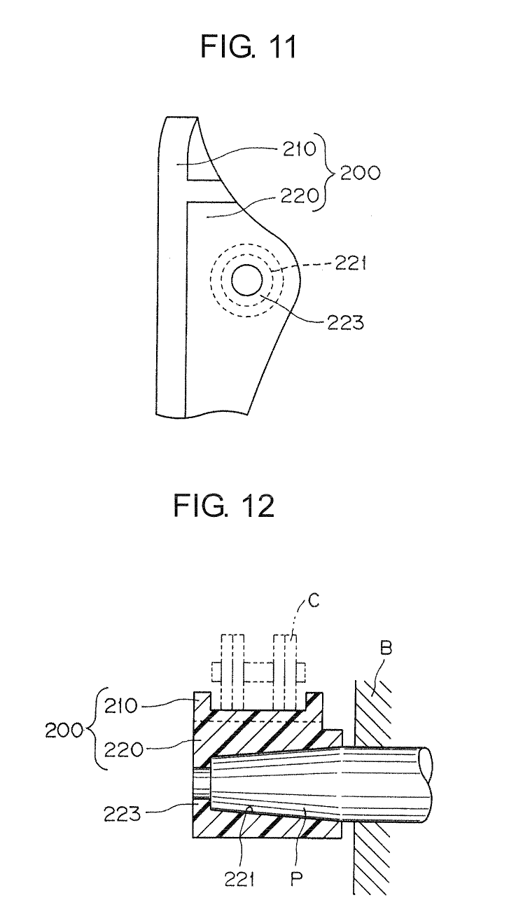

Because the guide can be readily positioned in alignment with the normal traveling locus of the timing chain, it is possible to reduce the noises that would otherwise be generated contact between the chain and a sidewall of the guide due to shifting of the chain to one side in the widthwise direction. FIGS. 11 through 24 illustrate further embodiments of the stationary guide.

The stationary guides of the second through seventh embodiments explained below are different from the stationary guide 100 of the first embodiment described above only in the specific configurations of the hole 121, the cap-like stop wall 123. In some cases, the mounting pin configuration differs from that of the mounting pins P in the first embodiment. Otherwise, the structure can be the same as that of the first embodiment. Corresponding parts are numbered with identical units and tens digits in different series starting with the 100s for the first embodiment, 200s for the second embodiment, 300s for the third embodiment, etc.

In the second embodiment, as shown in FIGS. 11 and 12, a hole 221 in the rail support 220 of a stationary guide 200 is provided with a cap-like stop wall 223 for preventing the stationary guide 200 from being erroneously mounted on the engine block. The hole 221 has a circular truncated cone-shaped inner wall, which is tapered from the pin insertion end toward the stop wall 223. Mounting of the stationary guide 200 is simplified because the mounting pin P, which is correspondingly tapered, is more readily guided into the mounting hole that in the case of a cylindrical pin which has a diameter substantially equal to the diameter of the entrance opening of a cylindrical mounting hole as in the first embodiment.

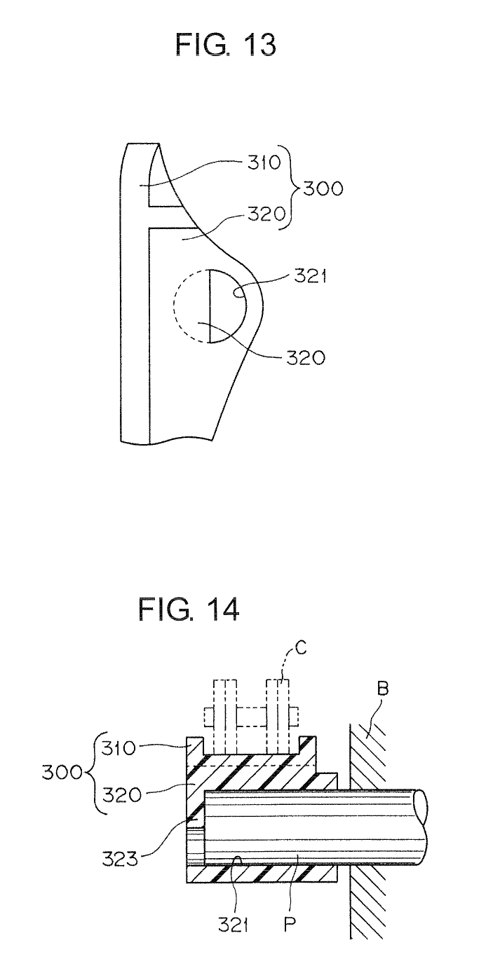

In the third embodiment, as shown in FIGS. 13 and 14, hole 321 in a rail support 320 of a stationary guide 300 is provided with a cap-like stop wall 323 for preventing the stationary guide 300 from being erroneously mounted on an engine block. The cap-like stop wall 323 has a half-moon shape and extends part way across the mounting hole 321. It has a planar face that meets the end of pin P as shown in FIG. 14. The effects of the stop wall are substantially the same as in the first embodiment. If the opening adjacent the stop wall is large, the amount of material composing the guide is slightly reduced.

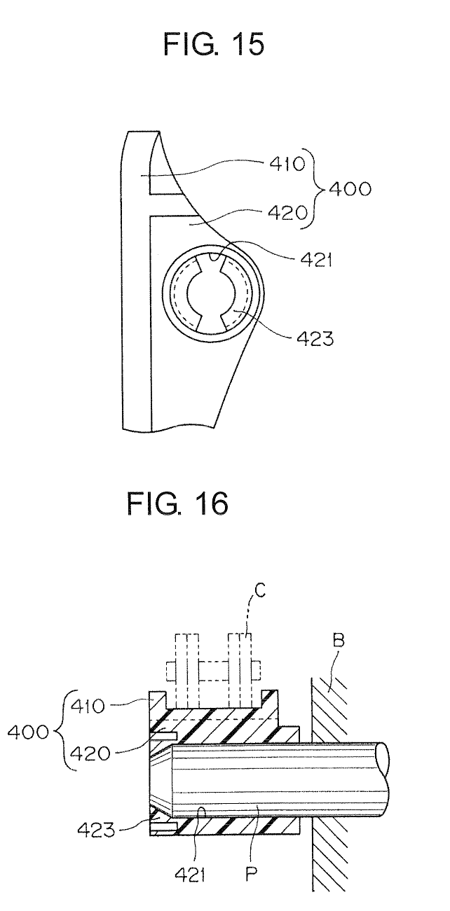

In the fourth embodiment, as shown in FIGS. 15 and 16, a hole 421 in the rail support 420 of stationary guide 400 is provided with a cap-like stop wall 423 for preventing the stationary guide 400 from being erroneously mounted to an engine block. Specifically, the stop wall 423 is composed of opposed wedge-shaped elements that are biased inwardly and conform to and engage a tapered end of the mounting pin. The remainder of the mounting pin is in the form of a cylinder that conforms to a cylindrical inner wall of hole 421. The configuration of the pin and the stop wall, and the biasing force exerted by the opposed, wedge-shaped elements, ensure a steady fit of the pin in the mounting hole.

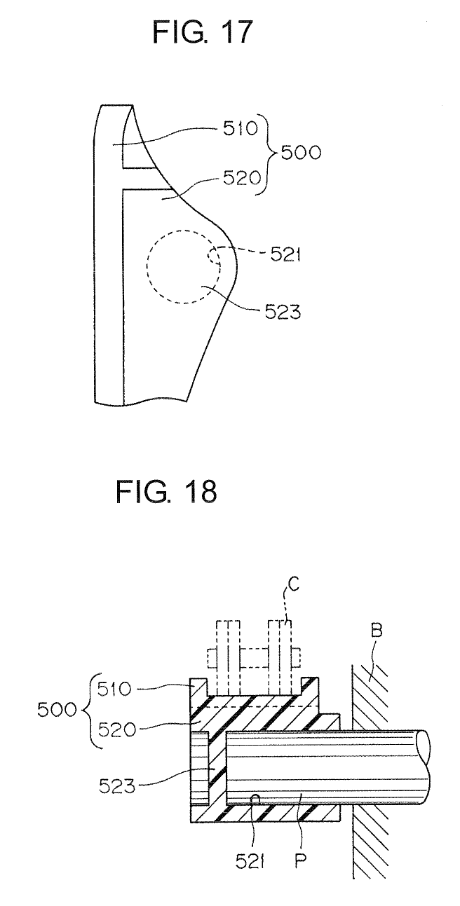

In the fifth embodiment as shown in FIGS. 17 and 18, a hole 521 in the rail support 520 of stationary guide 500 has a stop wall 523 for preventing the stationary guide 500 from being erroneously mounted on an engine block. In this embodiment the stop wall 523 completely closes off the mounting hole. The stop wall is also recessed from the side of the support opposite from the mounting hole 521, but the recess is insufficiently deep to retain a pin P when an attempt is made to mount the guide incorrectly.

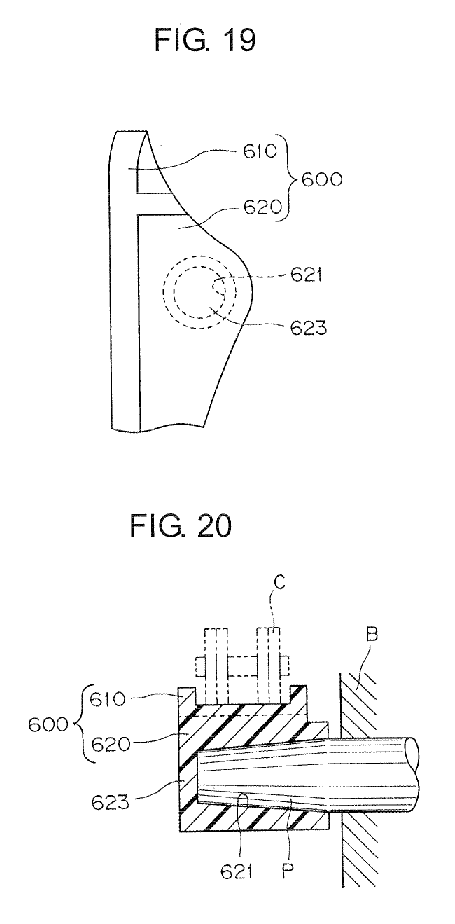

In the sixth embodiment, as shown in FIGS. 19 and 20, a hole 621 in the rail support 620 of a stationary guide 600 is provided with a cap-like stop wall 623 for preventing the stationary guide 600 from being erroneously mounted on the engine block. The hole 621 has a circular truncated cone-shaped inner wall, which is tapered from the pin insertion end toward the stop wall 623. The configuration is similar to that of the second embodiment shown in FIGS. 11 and 12, except that the stop wall 623 has no opening, and completely closes the end of mounting hole 621. As in the second embodiment, mounting of the stationary guide 600 is simplified because the mounting pin P, which has a taper corresponding to that of hole 621 is more readily guided into the mounting hole that in the case of a cylindrical pin which has a diameter substantially equal to the diameter of the entrance opening of a cylindrical mounting hole as in the first embodiment.

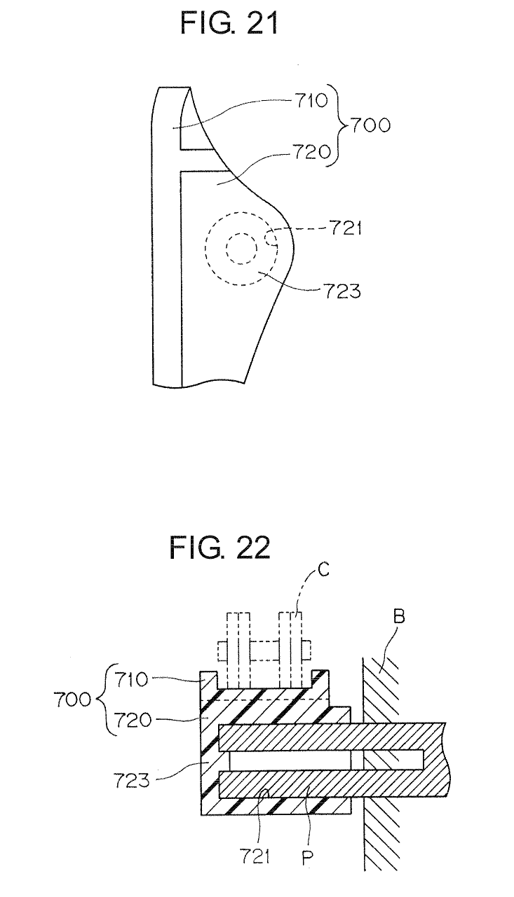

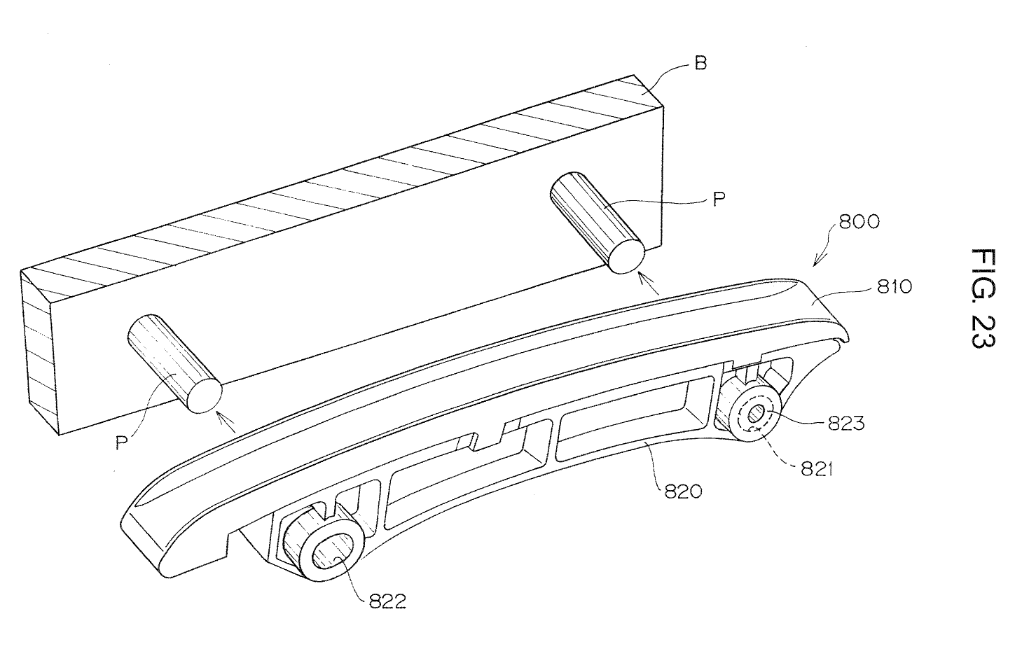

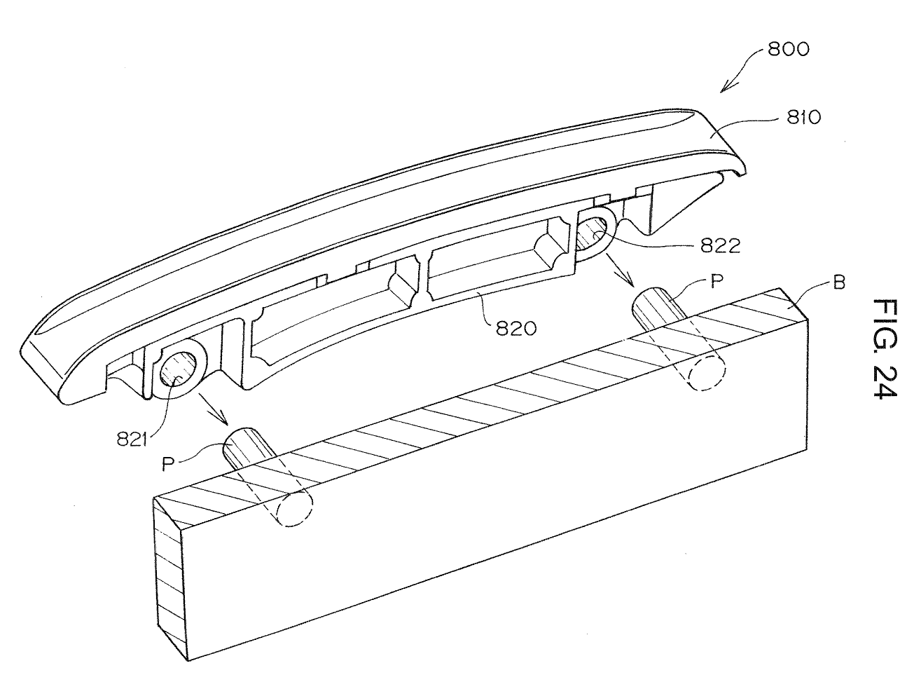

In the seventh embodiment, as shown in FIGS. 21 and 22, a mounting hole 721 in the rail support 720 of stationary guide 700 is provided with a stop wall 723 for preventing the stationary guide 700 from being erroneously mounted on the engine block wall. The mounting pin P is a hollow, externally cylindrical, pin, which extends into the mounting hole 721 of the guide, meeting the stop wall 723. Its hollow bore receives a projection formed at the center of the stop wall. In this embodiment, because the pin is hollow, the amount of material of which the pin is composed is reduced. However, the reduction in the amount of material causes the strength of the pin to be reduced. The reduction in strength can be compensated by shortening the hollow pin. If the hollow pin is shortened, the stop wall 723 can be made thicker, or located inward of the end of the mounting hole, as in the fifth embodiment shown in FIGS. 17 and 18. The protrusion on the stop wall can fit the bore of the mounting pin resiliently, thereby achieving a tight and steady fit of the pin in the mounting hole as in the fourth embodiment. Otherwise, the mounting pin has the same effects as the mounting pins of the previously described embodiments.

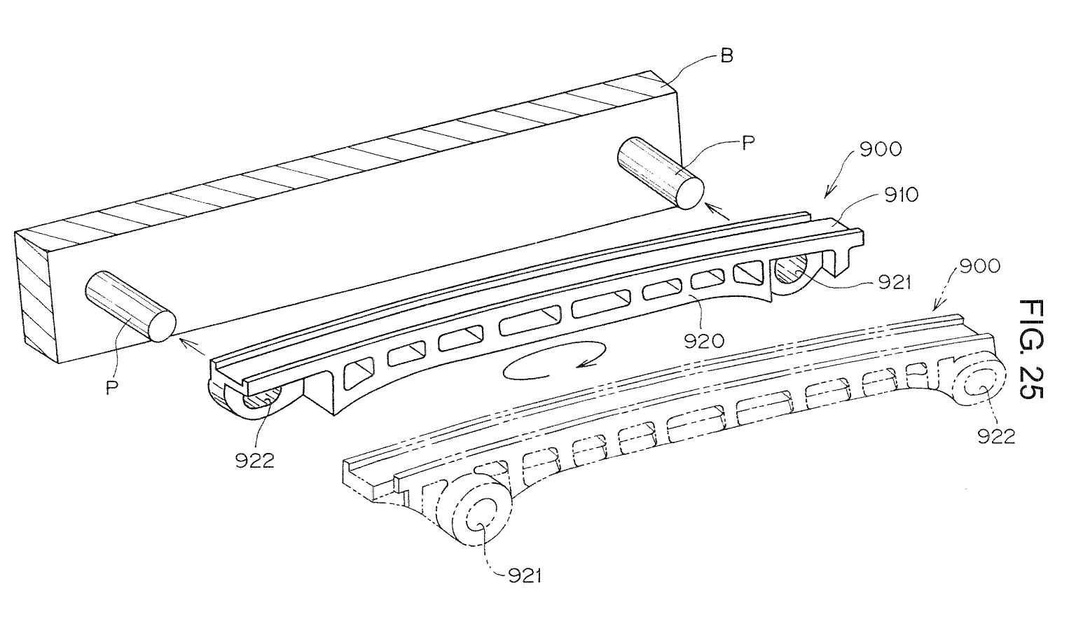

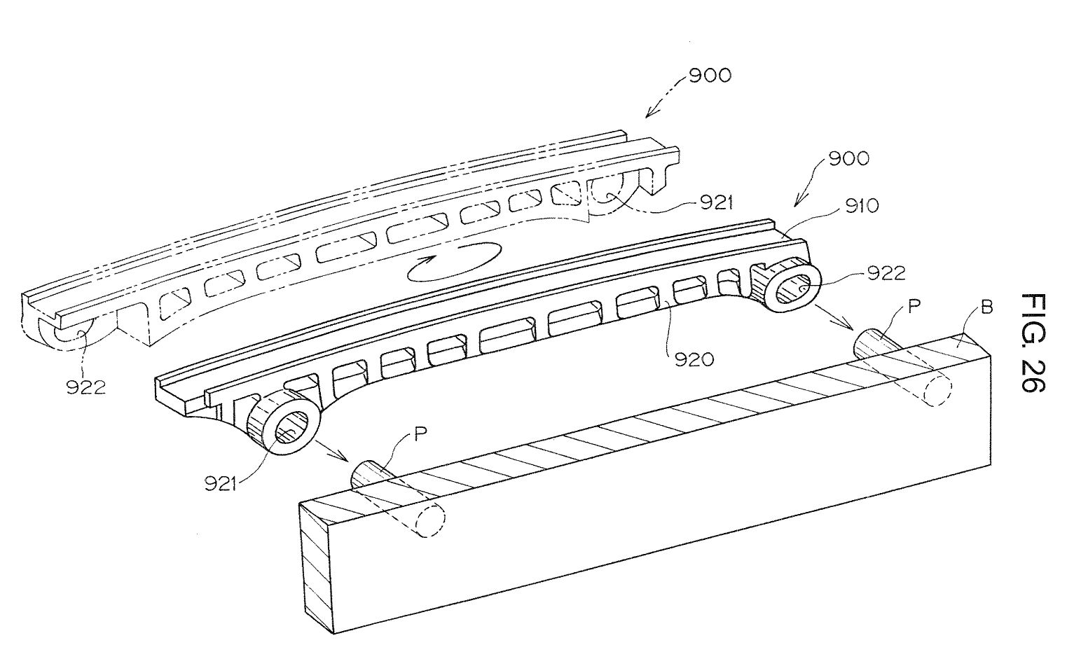

In the eighth embodiment illustrated in FIGS. 23 and 24, a stationary guide 800 differs from the stationary guides of the previously described embodiments in the specific configurations of the rail and the rail support. The rail 810 for controlling the travel of the timing chain C and the rail support 820 are supported on engine block wall B by fitting two holes 821 and 822 in the rail support 820 respectively onto two mounting pins P protruding from the engine block wall B. Hole 821 is provided with a cap-like stop wall 823 for preventing the stationary guide 800 from being erroneously mounted by reversal of the two holes 121 and 122.

The hole 822 is an elongated, oval-shaped hole whereas hole 821 is circular, in order to allow for longitudinal expansion and contraction of the guide. In this embodiment the rail 810 is formed separately from the rail support 820, and is a preferably a molded polymeric resin appropriately selected from polyamide resin, all aromatic resins, glass fiber-reinforced resins and the like. The rail differs from the rail support 820, which is preferably formed of metal, so that the coefficient of friction of the rail 810 against the timing chain C is reduced in comparison to the coefficient of friction in the case of a guide in which the rail and rail support are composed of the same metallic material. In this embodiment, the rail exhibits improved abrasion resistance and self-lubricating properties.

In each of the above-described embodiments, because the holes of the rail supports are provided with stop walls, it is easy to avoid erroneous assembly wherein the chain entry end and the chain exit end are reversed, and also easy to establish and maintain proper alignment of the guide with the normal path of chain travel.

The rail and rail support may be formed as a unit or separately. The specific configuration of the stop wall can be modified as long as it is provided at least in one of the mounting holes of the rail support and prevents the guide from being mounted erroneously. The hole having the stop wall can have an opening so that it is a through hole, or can be completely closed off by the stop wall. The specific position of the stop wall in its mounting hole can be varied as long as it prevents erroneous mounting of the guide on the mounting pins.

If the stop wall is positioned so that it is abutted by a mounting pin when the guide rail is properly positioned for alignment with the normal path of travel of the chain, adjustment of the insertion depth of the mounting pin becomes unnecessary.

What is claimed is:

1. A stationary guide for a transmission chain, comprising:
a rail for controlling travel of a timing chain, the rail having a longitudinal chain-engaging surface; and
a rail support extending along the longitudinal direction of the rail and supporting the rail;
wherein said rail support has first and second longitudinally spaced mounting holes for respectively receiving first and second supporting pins protruding from an engine block; and
wherein at least said first mounting hole has an internal stop wall offset sufficiently to engage the second supporting pin and thereby prevent the rail support from being erroneously mounted on said supporting pins when an attempt is made to mount the rail support with the first supporting pin in the second mounting hole and the second supporting pin in the first mounting hole.

2. In an engine comprising an engine block having first and second guide-supporting pins protruding therefrom, a timing chain transmission comprising a traveling timing chain, a stationary chain guide for sliding engagement with said chain, the stationary chain guide comprising:
an engine block;
a rail for controlling travel of said timing chain, the rail having a longitudinal chain-engaging surface; and
a rail support extending along the longitudinal direction of the rail and supporting the rail;
wherein said rail support has first and second longitudinally spaced mounting holes for respectively receiving said first and second supporting pins; and
wherein at least said first mounting hole has an internal stop wall offset sufficiently to engage the second supporting pin and thereby prevent the rail support from being erroneously mounted on said supporting pins when an attempt is made to mount the rail support with the first supporting pin in the second mounting hole and the second supporting pin in the first mounting hole.

3. An engine according to claim 2, wherein said internal stop wall is positioned within said first mounting hole at a location at which it is abutted by said first pin when the rail on said rail support is aligned with, and in normal sliding engagement with, said chain.
